(19) United States
(12) Patent Application Publication
(10) Pub. No.: US 2021/0326693 A1
(43) Pub. Date: Oct. 21, 2021

(54) NEURAL NETWORKS AND APPLICATIONS THEREOF

(71) Applicant: Vineet KUMAR, Mountain View, CA (US)

(72) Inventor: Vineet KUMAR, Mountain View, CA (US)

(21) Appl. No.: 16/852,930

(22) Filed: Apr. 20, 2020

(51) Int. Cl. G06N 3/08; G06N 3/04

(52) U.S. Cl. CPC G06N 3/08; G06N 3/04

(57) ABSTRACT

In one aspect neural networks are described herein. A neural network, in some embodiments, comprises a plurality of neurons, wherein the neurons are positioned according to at least one of learning functionality and weight. Moreover, the learning functionality can include rating of feature importance for a problem analyzed by the network.

### FIELD

The present invention relates to artificial intelligence and, in particular, to neural networks and methods of producing the same.

### BACKGROUND

Deep neural network are one of the most successful artificial intelligence and machine learning methods. These networks have at least one input layer, at least one output layer and at least one hidden layer. These models can be applied to variety of problems. For example, classification of hand written digits. MNIST data set [Yann] contains about 60000 images of handwritten digit 0 to 10 as shown in FIG. 1. These images can be used to generate a classification model.

Aurelien Geron on page 265 of [Gron: 2017], provided a scheme to use a deep neural network with following layers and nodes:

Input layer: 28×28 nodes
Hidden layer 1: 300 nodes
Hidden layer 2: 100 nodes
Output layer 3: 10 nodes.

The same network is depicted in FIG. 2. Additionally, [Yann] provides several other neural network (NN) architectures which provide a test error rate from 4.5% (in year 1998) to 0.35% (in year 2010). [Gron: 2017] discusses LeNet architecture developed in 1998 using convolutional neural network. [Yann] suggests that this architecture produced test error rate of 0.95%. Other CNN networks developed later, such as CVPR in year 2012 produced test error rate of 0.23%. These error rates are not achievable using methods of early 90s.

[Deng: 2013] discusses several deep neural network architectures applicable to speech recognition. Deep neural networks are also popular in image processing and computer vision. For example, Krizhevsky et al achieved a top-5 error of 15.3% on a 20000 categories classification problem using ImageNet dataset of more than 14 million images [Krizhevsky: 2017]. The neural networks are also applied to other machine learning problems such as regression, time series data production etc. [Chollet: 2017].

As state above these network models may have several hidden layers. The number of hidden layers correspond to the depth of the model and total number of nodes, filters, weights or trainable parameters indicate the size of the model. Deeper and larger models are more flexible and are able to approximate very complex non-linear functions. However, these models require more computations to train as well as make predictions on new data. Furthermore, these models tend to over-fit, i.e. they perform better on training data but fail to generalize the solution for test (and new) data. Therefore, there has been some work to reduce the size of the network without significant compromise in performance.

In general, [Gron: 2017] discusses selection of hidden layers and number of neurons per layer on page 271-272. The guidelines suggest selection using trial and error depending upon the problem complexity and the data. On number of neurons per hidden layer, Aurlien Gron pointed out
“Unfortunately, . . . , finding the perfect amount of neurons is still somewhat black art.”
   [Gron: 2017] further quotes a scientist at Google Inc. as:
“A simpler approach is to pick a model with more layers and neurons than you actually need, then use early stopping to prevent it from overfitting (and other regularization techniques, especially dropout, . . . . This has been dubbed the “stretch pants” approach . . . instead of wasting time looking for pants that perfectly match your size, just use large stretch pants that will shrink down to the right size.”

Seide et al developed a method to zero-out a subset of DNN weights that were below certain threshold value to reduce the number of independent parameters [Seide: 2011]. They arbitrarily selected number of weights to set zero as ⅔. LeCun et al also proposed similar scheme based upon second derivative of the loss function [LeCun: 1990]. Bottle-neck features are also proposed by Sainath et al and Grezl et al to achieve the same goals [Sainath: 2012, Grezl: 2008]. Sainath et al also proposed a low-rank matrix factorization of the weights in the final layer of the DNN to reduce the network size [Sainath: 2013]. Nakkiran et al proposed a scheme to reduce the size by using a low-rank approximation of the weights in the first hidden layer by means of a rank-constrained DNN layer topology [Nakkiran: 2015]. This approximation results in smaller number of trainable parameters.

In addition to network size problem discussed above, neural networks do not provide insight into learning capacity of the neurons as well as feature importance. For example, decision tree methods provide differentiation between weak and strong classifier. Regression methods also provide similar quantities in terms of p-values.

### SUMMARY

In one aspect neural networks are described herein. A neural network, in some embodiments, comprises a plurality of neurons, wherein the neurons are positioned according to at least one of learning functionality and weight. Moreover, the learning functionality can include rating of feature importance for a problem analyzed by the network.

In another aspect, methods of producing neural networks are described herein. In some embodiments, a method of producing a neural network comprises rearranging position of one or more neurons and/or neuron synapses according to at least one or learning functionality and weight during the training. In some embodiments, rearranging the positon of the one or more neurons is based on neuron weight during the training. Moreover, rearranging the position of the neuron synapses during the training can be based on synaptic strength.

In other embodiments, a method of producing a neural network comprises training and analyzing the neural network, and inducing a different output or function from the neural network via a different initialization scheme. In a further embodiment, a method of producing a neural network comprises training and analyzing the neural network, wherein cost function of the neural network is dependent upon neuron position in the neural network.

Method:

Neural network parameters (such as weights) are initialized as random numbers. Uniform random distribution, standard normal distribution and Xavier [Glorot] initialization are some of the common schemes. During the training of the network, the weights evolve which may depend upon the initialization, data, amount of training, and patterns to be learned. As a result, neurons are not positioned in any discernible fashion and the neuron weight matrices do not show any ordering. For example, adjacent neurons (or CNN filters) in the weight matrix are generally unrelated in terms of features learned or amount of learning.

In this work, we disclosed neural networks wherein the neurons are positioned according to at least one of learning functionality and weight. For example,
1. Neurons at certain positions are forced to learn certain aspects of the problem
2. Neurons in certain regions of the weight matrix have similar learning capabilities

The positioning may also be present in individual neurons. For example,
1. Synapses (weights within the neurons) are positioned depending upon feature importance for the problem or on some relation between the features.

These neural networks can be trained by forcing the neurons to have the desired positioning. This can be achieved by using different methods. We provide example using the following methods:
1. Selecting neuron weights to induce certain learning in neurons
2. Introducing position of neurons in the cost function to be optimized
3. Rearrangement of neurons during training based upon a metric, for example, neuron strength
4. Rearrangement of neuron and neuron synapses during training.

For rearrangement of neurons in example 3 and 4, a metric for rearrangement is required. The positioning in the neural network would be controlled by this metric. Although any metric derived from the neurons and/or data can be used; neurons learning strength is useful metric. This metric can produce neural networks which have clusters or groups of strong and weak neurons. Such a network can be very useful. For example, a subset of neuron containing strong neuron cluster can be used as a smaller network without significantly affecting the performance. The neuron clustering can be used to optimize the network size for retraining other networks.

### BRIEF DESCRIPTION OF THE DRAWINGS

FIG. 1. Examples of handwritten digits in MNIST dataset ref—[Yann]

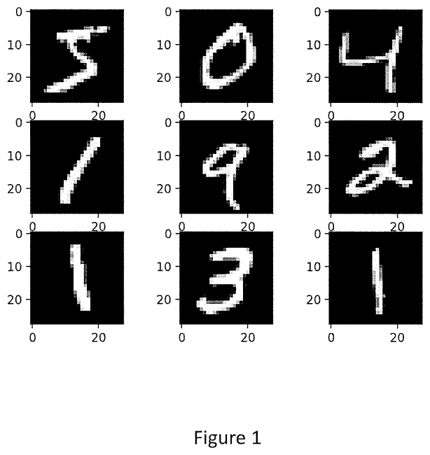

FIG. 2. Deep neural network described in ref—[Gron: 2017] to identify hand written digits of MNIST dataset

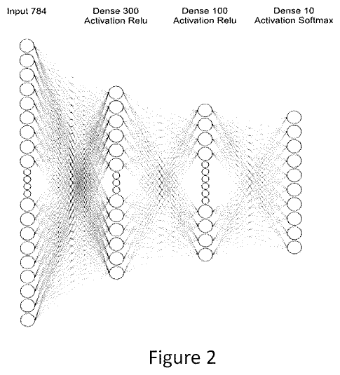

FIG. 3. A neural network to solve XOR problem

FIG. 4. Evolution of neuron weights during training of XOR problem

FIG. 5. Results of neural network training with use of structure loss. (a) neuron strengths, (b) loss and accuracy.

FIG. 6. A neural network for classifying species in IRIS flower dataset

FIG. 7. Result of neural network training without repositioning: (a) accuracy—no regularization, (b) neuron strength—no regularization, (c) accuracy—L1 regularization, (d) neuron strength—L1 regularization.

FIG. 8. Results of neural network training with repositioning: (a) accuracy—no regularization, (b) neuron strength—no regularization, (c) accuracy—L1 regularization, (d) neuron strength—L1 regularization.

FIG. 9. A neural network to classify speech of Alexa keyword detection data

FIG. 10. Effect of repositioning of neurons and neuron synapses on results of neural network training: (a) accuracy—no repositioning, (b) neuron strength—no repositioning, (c) accuracy—with repositioning, (d) neuron strength—with repositioning. All results with L1 regularization.

FIG. 11. Change in accuracy by excluding neurons positioned based upon strength.

FIG. 12. Results of training a small neural network with no neuron repositioning. (a) accuracy, (b) neuron strength

### DETAILED DESCRIPTION

The neuron learning strength described above can be formulated in various ways. Following are few choices for dense layer:
1. L1 norm of the neuron weights. Pᵢ=Σᵢ|Wᵢⱼ|. Here Pⱼ is the neuron strength and Wᵢⱼ is weight corresponding to i^{th} feature. |A| is absolute value of A
2. L2 norm of the neuron weights. Pⱼ=Σᵢ(Wᵢⱼ²)
3. Neuron activation. Pⱼ=Σₖ AₖᵢWᵢⱼ. Here Aₖᵢ is i^{th} input feature for K^{th} training example.
4. Neuron error contribution: How much each neuron contributes to the error to be minimized during training

The weak neurons described above can be defined as neurons with strength of zero or below a threshold ratio of strength of the strongest neuron.

As current state of the art, several neural networks with different sizes are trained and ones with balance of computation requirements and performance are used. This is a cumbersome task. The methods disclosed here provide insights into the optimum size of the network. These network can be used without retraining the subset.

As neural network is trained, weak neurons may add noise to the results or may cause over fitting problem. Since networks with positioning are able to exclude these neurons, it is possible that they generalize better on the test and new data.

We present below several ways of producing the networks with positioning by examples. Here we have used fully connected dense networks, however the same scheme is applicable to other types of networks such as convolutional neural networks, recurrent neural networks, networks with dropout, networks with low rank factorization etc.

### EXAMPLES

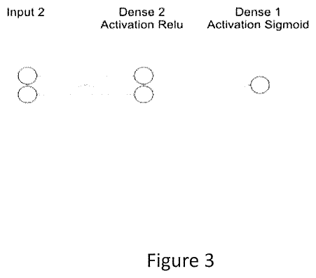

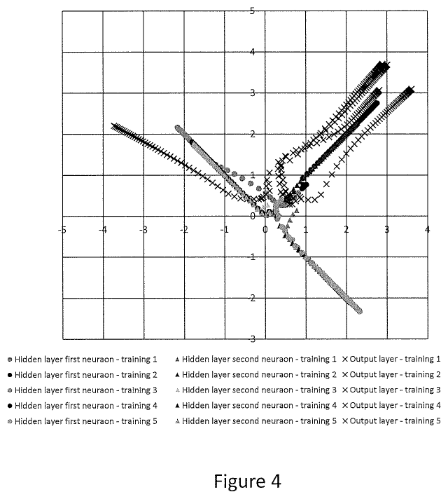

Example 1: Let's consider a neural network with two nodes in input layer, one hidden layer with two neurons and one output layer with one node to solve classical XOR problem as shown in FIG. 3. The hidden layer uses Relu activation whereas output layer uses the sigmoid activation function. We used squared difference between the predicted and target (or actual) values as the loss function which needs to be minimize during the training. We randomly select the initial weights of neurons 0 and 1 which evolve as shown in FIG. 4 for 5 independent trainings. The weights starts from [0 1] and evolve to about distance 2.5 from the origin. The FIG. 4 also suggests that neurons in the hidden layer evolve away from each other in diagonally opposite quadrants. For example, if the first neuron evolves to second quadrant, then second neurons evolve to the fourth quadrant and neuron in the output layer evolves to the quadrant in-between the quadrants of the hidden layer, namely, the first quadrant.

The XOR problem is a good example to discuss evolution of neuron weights and gain intuition of the training. The hidden layer neurons create linear boundaries which are combined by the output layer neuron for make final predictions. Depending upon random initialization, there are infinite sets of neuron weights which would lead to the solution. If we change the initialization method, we can force the neurons to evolve in certain ways. One example of the initialization can involve setting weights of the neuron such that sum of the weights is zero, however sum of the absolute values depends upon their index. For example, the first and the second neurons in the hidden layer can be initialized as [−0.1, 0.1] and [−0.2, 0.2], respectively. This initialization would be lead to a unique solution and the two neurons would learn certain decision boundaries predetermined by the problem being modeled. If we want to swap the learnings of the neurons, we can do it by swapping the initial weight values.

It is also possible to train a network first and develop an initialization scheme using the learned weights and retraining again such that retraining produces the positioning of the neuron weights.

Example 2: For differentiating the neurons based upon the learning, we may need to formulate degree of learning; we refer this to as strength of the neuron. Strong neurons have a higher degree of learning and contribute more in making the prediction. For example, average activation or linear sum produced by a neuron can be used as its degree of learning. In general, this requires consideration of the neuron weights and training data (page 428 [Gron: 2017]).

Other choice could be inferring degree of learning from neuron weights. Since input data is generally normalized in practice; it is reasonable to assume that the inputs for each neuron are centered in [−1 1] or [0 1] and the magnitudes do not very much. If we use batch normalization, this assumption would be correct. We can redefine the neuron strength using this assumption without the input data. One choice of the strength metrics could be L1 or L2 norm for the neuron. The L1 norm would be sum of absolute weights of the neurons.

In this example, we selected a sum of absolute values of weights as the strength of a neuron.

In training the neural networks, cost function treats all neurons equally from the neuron position perspective, i.e., it does not include neuron positions in the equation. We can evolve the neurons in certain ways by making cost function depend upon the neuron positions (index).

In this example, we modify the cost function by adding a positioning loss term S depending upon strength metrics and the neuron index as:

$$S = c {\sum }_{i} 2 ( i - 0.5 ) {s}_{i}$$

Where sᵢ is the strength of i^{th} neuron. We used c=0.001 and the value of position index i is 0 and 1 for the first and the second neuron, respectively. Rest of the model and training is similar to explained in the example above. The positioning loss function is selected such that the higher strength of first neuron reduces the total loss function and higher strength of the second neuron increases the total loss function, the optimization scheme should find a path such that first neuron has higher strength. We trained the model 20 times and found that 70% of randomly uniformly initialized weights are obtained as expected. The network does not train well in 15% cases and in other 15% cases second neuron was stronger.

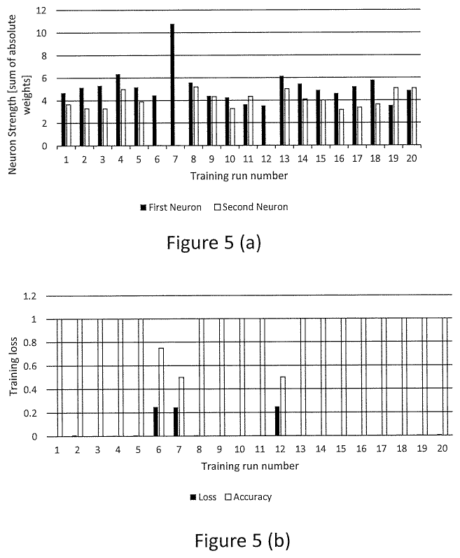

The results obtained from the trainings are shown in FIG. 5. The results show that the first neuron has higher strength most of the times. In run 11, 19 and 20 the second neuron was stronger. All runs except 6, 7 and 12 achieved 100% training accuracy. We believe that addition of index and strength in loss function makes the loss surface more complex. This might result in more local minima and potential places for network to get stuck and not be able to minimize loss.

Example 3: If we do not include the index of neuron in the cost function as done example 2, the positioning of neurons does not affect the activation and the loss function. In a dense neural network, all nodes in a layer are connect to all of the nodes in the next layer. The neurons are represented by columns of the weight matrix. The linear sum used in the activation is a dot product of input features and neuron weights. Changing the positions of the neurons does not affect the liner sum and the activation. If A is the activation produced by the previous layer and W is the neuron weight matrix such that:

$$A = [ {a}_{1} , \begin{matrix}{a}_{2 , … ,} & {a}_{n}\end{matrix} ]$$

$$W = [ \begin{matrix}{W}_{11} & … & {W}_{1 k} \\ ⋮ & ⋱ & ⋮ \\ {W}_{n 1} & … & {W}_{nk}\end{matrix} ]$$

If f is the activation function, the layer with weight matrix W would produce activation A′.

$${A}^{′} = [ {a}_{1}^{′} , \begin{matrix}{a}_{2 , … ,}^{′} & {a}_{k}^{′}\end{matrix} ]$$

$${a}_{1}^{′} = f ( {\sum }_{i = 1}^{n} {w}_{i 1} {a}_{i} )$$

$${a}_{2}^{′} = f ( {\sum }_{i = 1}^{n} {w}_{i 2} {a}_{i} )$$

$${a}_{k}^{′} = f ( {\sum }_{i = 1}^{n} {w}_{i k} {a}_{i} )$$

It is clear from the above equation that swapping two neuron by swapping columns of the weight matrix W results in swapping of elements of activation matrix A′. For this layer, one may imaging that swapping the neuron may confuse the neuron since we are swapping the feature they were trying to learn. However, it is not the case because, we are also swapping their learning done so far. This is equivalent to having their initialized weights swapped.

However, the implications for the next layers are not so straight forward. If we swap the neurons, input of the next layer are also swapped. Here, we would be changing the input features the neurons of the next layer are going to learn; therefore they need to change their evolution course. As we stated earlier in example 1, neural networks evolve to make linearly inseparable features into linearly separable features; the neurons with similar learning strengths may cross their learning paths. If neurons are swapped at the similar stage, the network may show resilience and continue to evolve to in correct direction. If we swap neurons with mature learning and week learning, the network may not be able to get back on the right evolution path and may get stuck in some local minima. It is worth noting that loss function is independent of the neuron positioning. Therefore, a flexible network should be capable of finding the right solution. For keeping the neurons positioned according to their learning strengths, we might need to keep them positioned from the beginning and reposition them before two neurons differ significantly in their strengths and learning.

We used IRIS flower dataset for this example [Iris]. This dataset contains 150 instances of 3 species of Iris flowers, namely, Setosa, Verginica and Versicolor. For each instance, length and width of sepals and petals are provided which we use to learn and predict the flower species type.

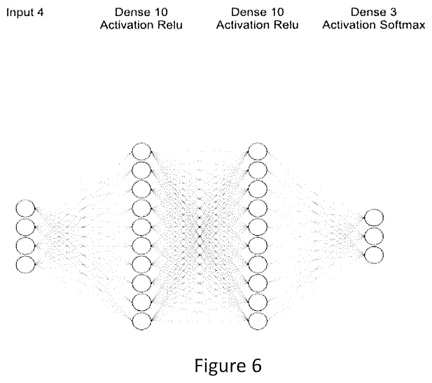

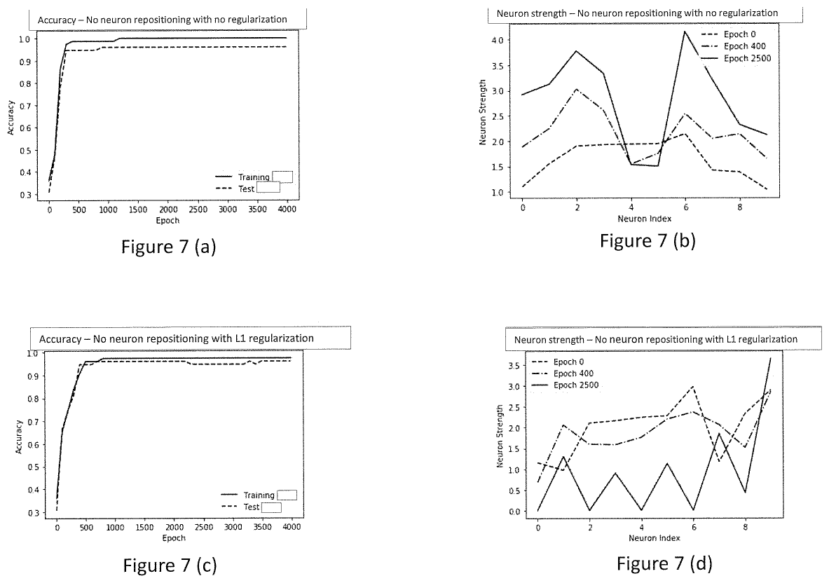

First we trained a deep neural network following a conventional scheme. We used two hidden layers with 10 neurons each with Relu activation function as shown in FIG. 6. Input and output layers had 4 and 3 nodes, respectively. We used softmax function for output layer. We used mean squared difference between the prediction and actual flower species label as the loss function. We used randomly selected 75 instances as training data and the rest 75 instances as the test data. We used sum of absolute weights as strength metric of a neuron. FIG. 7a shows that the network trains well with accuracy of over 96% for train and test data. The neuron strength for the first hidden layer shown in FIG. 7b varies from 1.5 to 4 with no clear grouping, ordering or positioning.

Next, we applied L1 regularization to the loss function by adding 5% of mean of absolute values of weights of each layer. The application of L1 regularization constrains the weights. It might completely eliminate weights of the least import feature [Gron: 2017]. FIG. 7c shows that this model trains well. Neuron strengths in FIG. 7d indicate lower neuron strength for all neurons (range [0 3.5]) as compared to FIG. 7b.

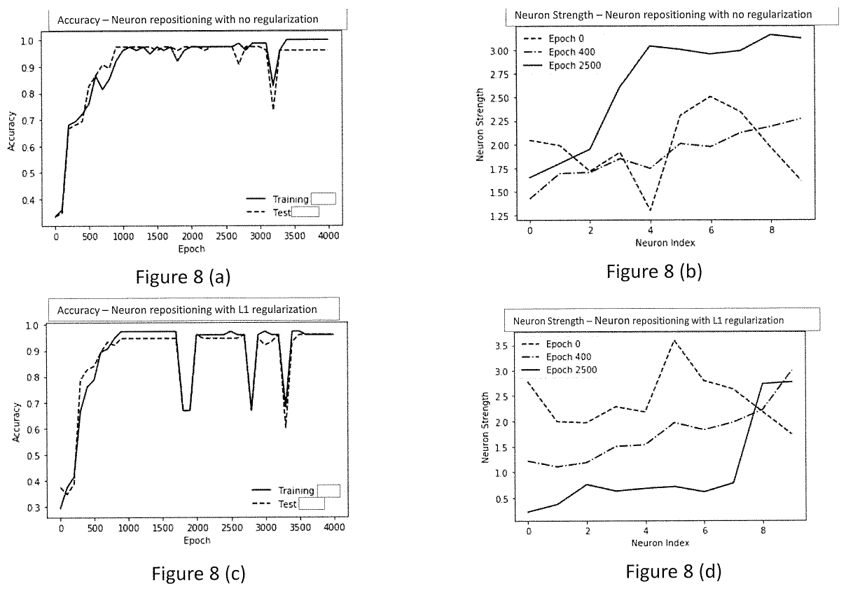

FIG. 8 shows forcing the network to have neuron positioning by neuron rearranging according to their strength. The reordering of neurons was performed once every 100 epochs until 80% of the training process is completed by sorting them in ascending order of their strength. For neuron reordering without regularization (FIG. 8a), we notice that the network trains well, however, the training is not smooth. It has bumps every 100 epochs. As mentioned earlier, the reordering of the neurons may cause confusion for subsequent layers. However, the network is resilient to continue on the path to minimize the loss. In the end, the model trains with accuracy similar to models with no rearrangement. FIG. 8b shows neuron strength in layer 1. This layer has 10 neurons, the neuron index refers to columns of the weight matrix. This figure indicates that higher index neurons are stronger.

FIG. 8c shows effects of neurons rearrangement with L1 regularization. Since neuron weights are constrained, this model is much smoother with fewer events of network confusion. Neuron strengths in FIG. 8d bottom right show that neurons can be grouped based upon their position; lower index has weaker neurons whereas higher index has stronger neurons.

Example 4: In this example we rearrange the neurons as well as arrange weights of each neuron for the next layer. This helps alleviating confusion problem observed in the previous example. Suppose we have activation of previous layer A, a hidden layer W with k neurons and other hidden or output layer W′ with k′ neurons. The layers have bias B and B′

$$A = [ {a}_{1} , \begin{matrix}{a}_{2 , … ,} & {a}_{n}\end{matrix} ]$$

$$W = [ \begin{matrix}{W}_{11} & … & {W}_{1 k} \\ ⋮ & ⋱ & ⋮ \\ {W}_{n 1} & … & {W}_{nk}\end{matrix} ]$$

$$W = [ \begin{matrix}{W}_{11}^{′} & … & {W}_{1 {k}^{′}}^{′} \\ ⋮ & ⋱ & ⋮ \\ {W}_{n 1}^{′} & … & {W}_{{nk}^{′}}^{′}\end{matrix} ]$$

$$B = [ {b}_{1} , \begin{matrix}{b}_{2 , … ,} & {b}_{k}\end{matrix} ]$$

$${B}^{′} = [ {b}_{1}^{′} , \begin{matrix}{b}_{2 , … ,}^{′} & {b}_{{k}^{′}}^{′}\end{matrix} ]$$

If two layers have activation A′ and A″ using activation function f, the activations can be given as:

A′=[a′₁,a′₂, . . . ,a′ₖ]

A″=[a″₁,a″₂, . . . ,a″_{k′}]

A′=f(AW+B)

A″=f(A′W′+B′)

Now components of A′ would be

a′₁=f(b₁+w₁₁a₁+w₂₁a₂+ . . . +wₙ₁aₙ)

a′₂=f(b₂+w₁₂a₁+w₂₂a₂+ . . . +wₙ₂aₙ)

a′ₖ=f(bₖ+w₁ₖa₁+w₂ₖa₂+ . . . +wₙₖaₙ)

And components of A″ would be:

a″₁=f(b′₁+w′₁₁a′₁+w′₂₁a′₂+ . . . +w′ₙ₁a′ₙ)

a″₂=f(b′₂+w′₁₂a′₁+w′₂₂a′₂+ . . . +w′ₙ₂a′ₙ)

a″_{k′}=f(b′_{k′}+w′₁ₖa′₁+w′₂ₖa′₂+ . . . +w′_{nk′}a′ₙ)

If we reorder neurons in layer 1 by reordering columns of W, while activation values in A′ remain the same, but become reordered as well. For example, if we swap first two columns of Wand first two elements of B, the activations would be:

a′₁=f(b₂+w₁₂a₁+w₂₂a₂+ . . . +wₙ₂aₙ)

a′₂=f(b₁+w₁₁a₁+w₂₁a₂+ . . . +wₙ₁aₙ)

If we swap first two rows of W″, we may obtain the same activation A″.

a″₁=f(b′₁+w′₂₁a′₂+w′₁₁a′₁+ . . . +w′ₙ₁a′ₙ)

a″₂=f(b′₂+w′₂₂a′₂+w′₁₂a′₁+ . . . +w′ₙ₂a′ₙ)

a″_{k′}=f(b′_{k′}+w′₂ₖa′₂+w′₁ₖa′₁+ . . . +w′_{nk′}a′ₙ)

We applied this method to Alexa keyword detection data [Kaggle]. There were three classes ‘alexa’, ‘garbage’ and ‘background’. Each class contained 1800 examples with 1960 features in frequency space. We used 1500 examples from each class for training and 300 for testing/validation. We normalized the training data using minmax method in range [0 1].

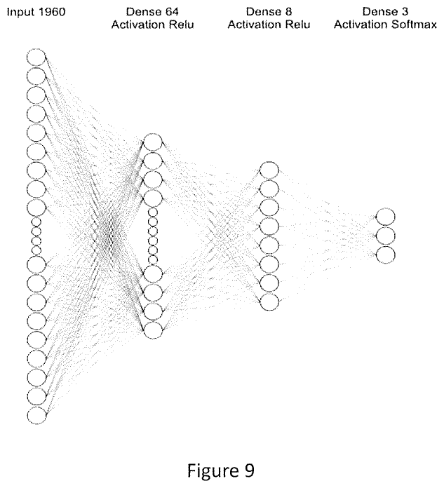

We used a 2 hidden layer neural network with 64, and 8 neurons with Relu activation function as shown in FIG. 9. We used softmax activation function for the output layer. The neuron weights were initialized using Xavier's method. Similar to previous example, we used mean squared difference between the prediction and actual class label as loss function. We added L1 regularization term as 5% of mean of absolute weights for each layer.

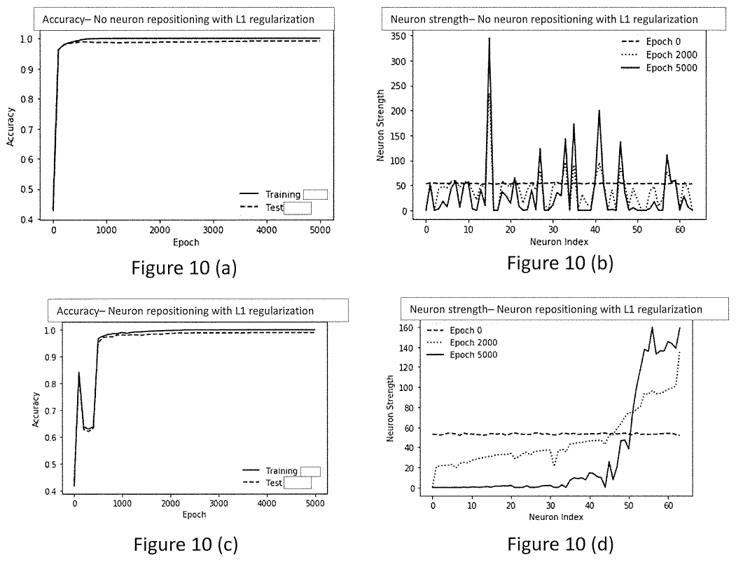

FIG. 10a shows the train and test accuracy as a function of training epochs. The model was able to achieve over 99% training and test accuracy. FIG. 10b top right shows weight strength for the first layer. The initial strength for the neurons was about 55 in the beginning which evolved in 0 to 40 range. Several neurons have zero weights whereas few neurons have very high weights.

We applied repositioning of neurons for the neurons in the first layer and reposition of weights in the neurons (i.e. synapses) for the second layer. The results shown in FIG. 10c suggest that the model finally trains with train and test accuracy similar to model in FIGS. 10a and 10b. FIG. 10c also shows that repositioning of neurons has interrupted the learning but the model was quickly able to bounce back to the higher accuracy. FIG. 10d bottom right shows the positioning in neuron strengths. Several neurons with lower index are very weak. Most neurons have strength on 0 to 55 whereas few neurons are very strong towards the higher index side of the layer.

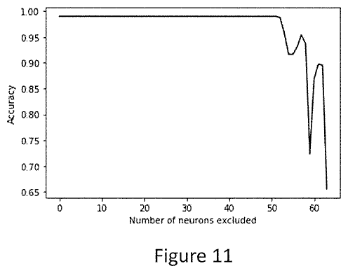

Due to the positioning in the first hidden layer, it would be possible to use a subset of neurons in the first hidden layer and correspondingly subset of weights in neurons (i.e. synapses) for the next layer. FIG. 11 shows test error obtained using a subset of network by excluding neurons from beginning of the first layer and the same number of rows in weight matrix of second layer. This figure shows that accuracy does not change until 50 neurons have been excluded. This suggests that last 14 neurons have sufficient learning to make the correct predictions.

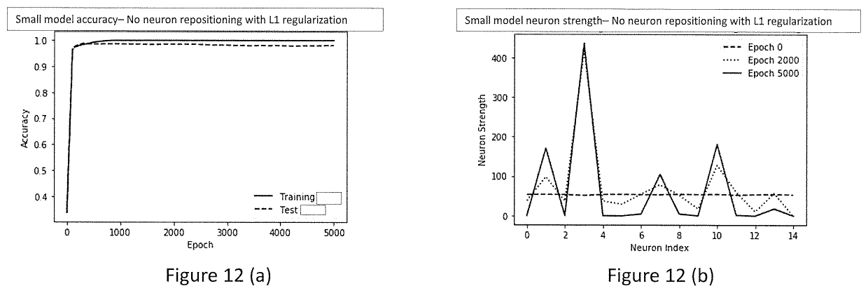

We subsequently developed a network similar to the one used in FIG. 10a but with 15 neurons in the first hidden layer. The accuracy and weight strengths of this network are shown in FIGS. 12a and 12b. The smaller network suggested by repositioning method is also able to produce similar performance.

1. A neural network comprising:
a plurality of neurons, wherein the neurons are positioned according to at least one of learning functionality and weight.

2. The neural network of claim 1, wherein the learning functionality includes a rating of feature importance for a problem analyzed by the network.

3. A method of producing a neural network comprising:
rearranging position of one or more neurons and/or neuron synapses according to at least one of learning functionality and weight during the training.

4. The method of claim 3, wherein rearranging the position of the one or more neurons is based on neuron weight during the training.

5. The method of claim 3, wherein rearranging the position of the neuron synapses during the training is based on synaptic strength.

6. A method of producing a neural network comprising:
training and analyzing the neural network; and
inducing a different output or function from the neural network via a different initialization scheme.

7. A method of producing a neural network comprising:
training and analyzing the neural network, wherein cost function of the neural network is dependent upon neuron position in the neural network.
